(19) United States
(12) Patent Application Publication
(10) Pub. No.: US 2010/0122681 A1
(43) Pub. Date: May 20, 2010

(54) Two-Part piston for an internal combusion engine

(76) Inventor: Wolfgang Issler, Schwaikheim (DE)

Correspondence Address: COLLARD & ROE, P.C., 1077 NORTHERN BOULEVARD, ROSLYN, NY, 11576, US

(21) Appl. No.: 12/590,971

(22) Filed: Nov. 17, 2009

(30) Foreign Application Priority Data
Nov. 20, 2008 (DE) 10 2008 058 190.9

(51) Int. Cl. F02F 3/00

(52) U.S. Cl. 123/193.6

(57) ABSTRACT

A two-part, cooled piston for an internal combustion engine has an upper piston part and a lower piston part, in which the piston parts are screwed together by way of a threaded pin disposed on the upper piston part and a threaded bore worked into the lower piston part. The material of the threaded pin, in order to improve its strength, has a stretching limit that is higher in comparison with the rest of the piston material. The increase in the stretching limit is achieved by means of lasting stretching of the threaded pin by approximately 1% of its length, in the axial direction.

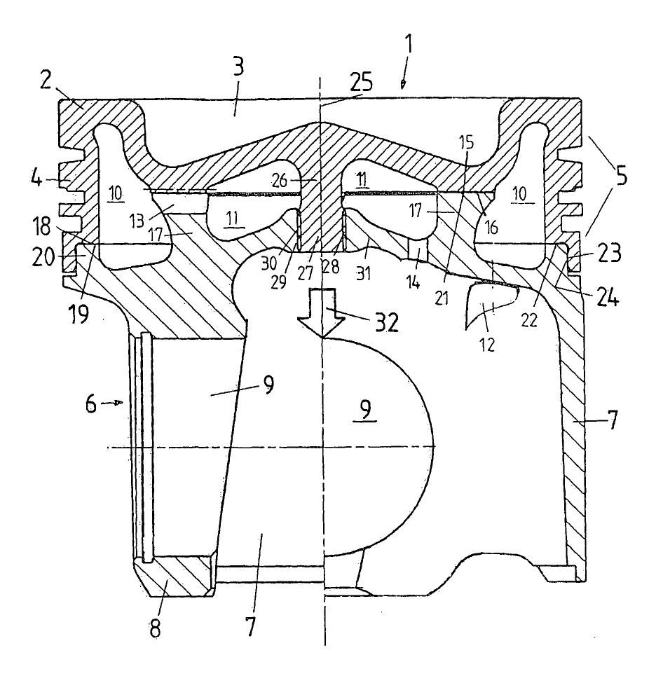

### CROSS REFERENCE TO RELATED APPLICATIONS

Applicant claims priority under 35 U.S.C. 119 of German Application No. 10 2008 058 190.9 filed Nov. 20, 2008.

### BACKGROUND OF THE INVENTION

1. Field of the Invention

The invention relates to a two-part piston for an internal combustion engine.

2. The Prior Art

A two-part cooled piston for an internal combustion engine having an upper piston part and a lower piston part is described in German Patent Application No. DE 102 57 022 A1, in which the piston parts are screwed together by way of a threaded pin disposed on the upper piston part and a threaded bore worked into the lower piston part. This piston has the disadvantage that during engine operation, an axially directed force that goes beyond the stretching limit of the threaded pin material can be exerted, which leads to permanent longitudinal stretching of the threaded pin and thus to loosening of the screw connection between the upper part and the lower part of the piston.

### SUMMARY OF THE INVENTION

It is therefore an object of the invention to avoid this disadvantage of the state of the art. This object is accomplished according to the invention by a two part piston for an internal combustion engine comprising an upper piston part having a ring wall and a ring belt, and a lower piston part that forms an outer, ring-shaped cooling channel with the upper piston part and an inner, ring-shaped cooling channel. The piston has a box-shaped piston skirt having two pin bosses connected with it. The upper piston part has a threaded pin disposed on the side facing the lower piston part, coaxial to the longitudinal axis of the piston. The lower piston part has a threaded bore disposed on the side facing the upper piston part, coaxial to the longitudinal axis of the piston. The threaded bore has an inside thread that matches the thread of the threaded pin. The threaded pin can be screwed into the threaded bore in order to assemble the upper piston part to the lower piston part. The threaded pin has a stretching limit that is higher in comparison with the rest of the piston.

The stretching limit of the threaded pin can be increased by plastic deformation, i.e., stretching or compression, of the threaded pin in the axial direction, prior to assembly of the upper piston part with the lower piston part. This increases the stretching limit to such an extent that at the tensile stress on the threaded pin that is usual during engine operation, there is no risk of plastification of the threaded pin material and thus of loosening of the screw connection between upper piston part and lower piston part.

The threaded pin can be plastically deformed by 0.5% to 5% of its length, and preferably by about 1% of its length, in the axial direction, proceeding from the finished upper piston part, in order to increase the stretching limit of the pin. For example, the threaded pin can be stretched in the axial direction toward the lower piston part in order to increase the stretching limit of the threaded pin. The plastic deformation causes a lasting stretching of the piston pin material, so that the stretching limit of the pin is increased as compared with the rest of the piston.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

The drawing shows a sectional diagram of a piston, whose left half represents a half-section of the piston in the pin direction, and whose right half represents a half-section of the piston in the pressure/counter-pressure direction.

### DETAILED DESCRIPTION OF THE PREFERRED EMBODIMENT

The FIGURE shows a two-part cooled piston 1 that consists of an upper piston part 2 that has a combustion bowl 3 and a ring wall 4 having a ring belt 5, and of a lower piston part 6 that comprises a box-shaped piston skirt 7 and two pin bosses 8, each having a pin bore 9 for accommodating a piston pin, not shown in the FIGURE, connected with it. Upper piston part 2 and lower piston part 6 delimit an outer ring-shaped cooling channel 10 and an inner cooling channel 11 disposed concentric to the former. Outer cooling channel 10 has at least one inflow opening 12 for introducing cooling oil, and is connected with inner cooling channel 11 by way of at least one overflow channel 13. Overflow channel 13 can be configured as a bore. For example, two overflow channels 13 that lie opposite one another can be provided. Inner cooling channel 11 has at least one run-off bore 14, by way of which the cooling oil can exit from inner cooling channel 11.

Upper piston part 2 can be mounted on an upper contact surface of a ring-shaped support rib 17 of lower piston part 6, by way of a ring-shaped contact surface 15 that is disposed on the side of upper piston part 2 that faces away from combustion bowl 3, and on an upper cross-sectional surface 19 of a ring-shaped support crosspiece 20 of the lower piston part 6, by way of a cross-sectional surface 18 situated on the underside of ring wall 4. In this way, contact surfaces 15 and 16 form an inner contact region 21 disposed in planar and horizontal manner, or configured in the manner of a roof or plate, and cross-sectional surfaces 18 and 19 form an outer contact region 22 disposed coaxial to inner contact region 21 and horizontally, or also configured in the manner of a roof or plate.

Support crosspiece 20 is configured in step shape, so that upper piston part 2 can be centered by way of a cylindrical recess 23 worked into the inside of the lower part of ring wall 4. Thus, when the upper piston part and lower piston part are assembled, the inner wall of cylindrical recess 23 comes into contact with cylindrical face side 24 of support crosspiece 20, and it is necessary for the inside diameter of cylindrical recess 23 to be larger than the outside diameter of cylindrical face side 24 of support crosspiece 20, by such a tolerance dimension that problem-free assembly of upper part 2 onto lower part 6 is guaranteed.

On the side facing away from combustion bowl 3, upper piston part 2 has a pin 26 that is disposed centered and coaxial to longitudinal axis 25 of piston 1, whose end 27 is provided with a thread 28. Region 31 between ring-shaped support rib 17 of lower piston part 6, which delimits inner cooling channel 11 together with upper piston part 2, is configured to have a relatively thin wall, and in its center is provided with a bore 29 that is disposed coaxial to longitudinal axis 25 of the piston 1, which bore has an inside thread 30 that matches thread 28 of pin 26.

This makes it possible that during assembly of piston 1, only threaded pin 26 of upper piston part 2 has to be screwed into threaded bore 29 of region 31. The elasticity of the relatively thin-walled region 31 brings about the result that it deforms like a disk spring when the upper piston part and lower piston part are screwed together, and the inner center of region 31, provided with threaded bore 29, domes up in the direction of upper piston part 2. In addition, the thread-free expansion shaft of threaded pin 26 lengthens during assembly, making it possible to achieve a further improvement in the reliability of the seat of upper piston part 2 on lower piston part 6. In this way, both contact surfaces 15 and 16 of inner contact region 21 and cross-sectional surfaces 18 and 19 of outer contact region 22 are pressed onto one another, thereby sealing the inner and outer cooling channels 10 and 11. The strength of the assembly of the upper piston part and lower piston part is therefore increased to such an extent that an additional nut, i.e. a locknut, is not required to achieve a permanent assembly connection. Experiments have shown that a sufficient bias of the two parts of the piston is guaranteed under all possible operating conditions.

Upper piston part 2 preferably consists of an oxidation-resistant and heat-resistant material. Lower piston part 6 preferably consists of a ferrite-perlite annealed steel that is precipitation-hardened.

In engine operation, there is the risk, in this connection, that a force in the direction of arrow 32 will be exerted on pin 26, particularly during the intake stroke, which force goes beyond the stretching limit of the pin material, and leads to lasting longitudinal stretching of this material and thus to loosening of the screw connection between upper piston part 2 and lower piston part 6 of piston 1. For this reason, it is proposed, according to the invention, to increase the stretching limit of the pin material prior to assembly with the lower piston part by subjecting the pin to controlled tensile stress in the cold state, so that it is permanently stretched in the axial direction by approximately 1% of its length, without the ductility of the pin material being impaired.

Accordingly, while only a few embodiments of the present invention have been shown and described, it is obvious that many changes and modifications may be made thereunto without departing from the spirit and scope of the invention.

### REFERENCE SYMBOL LIST

1 piston

2 upper piston part

3 combustion bowl

4 ring wall

5 ring belt

6 lower piston part

7 piston skirt

8 pin boss

9 pin bore

10 outer cooling channel

11 inner cooling channel

12 inflow opening

13 overflow channel, bore

14 run-off bore

15 contact surface of the upper piston part 2

16 contact surface of the lower piston part 6

17 support ribs

18 cross-sectional surface of the upper piston part 2

19 cross-sectional surface of the lower piston part 6

20 support crosspiece

21 inner contact region

22 outer contact region

23 recess of the ring wall 4

24 face side of the support crosspiece 20

25 longitudinal axis of the piston 1

26 pin, threaded pin

27 end of the pin 26

28 thread

29 bore, threaded bore

30 inside thread of the bore 29

31 region between the support ribs 17

32 arrow

What is claimed is:

1. A two-part cooled piston for an internal combustion engine, comprising:
an upper piston part having a ring wall and a ring belt;
a lower piston part that forms an outer, ring-shaped cooling channel and an inner, ring-shaped cooling channel with the upper piston part, said lower piston part further comprising a box-shaped piston skirt having two pin bosses connected with the piston skirt; and
a threaded pin disposed on a side of the upper piston part that faces the lower piston part, coaxial to a longitudinal axis of the piston,
wherein the lower piston part has a threaded bore disposed on a side facing the upper piston part, coaxial to the longitudinal axis of the piston, said bore having an inside thread that matches a thread of the threaded pin, such that the threaded pin can be screwed into the threaded bore in order to assemble the upper piston part to the lower piston part;
and wherein the threaded pin has a stretching limit that is higher in comparison with a stretching limit of a rest of the piston.

2. The piston according to claim 1, wherein the stretching limit of the threaded pin is increased by plastically deforming the threaded pin by 0.5 to 5% of a length of the threaded pin, proceeding from a finished upper piston part.

3. The piston according to claim 2, wherein the threaded pin is plastically deformed by approximately 1% of its length.

4. The piston according to claim 2, wherein the threaded pin, proceeding from the finished lower piston part, is stretched in the axial direction in order to increase the stretching limit of the threaded pin.
